(19) United States
(12) Patent Application Publication
(10) Pub. No.: US 2015/0114142 A1
(43) Pub. Date: Apr. 30, 2015

(54) FAULT SIMULATOR FOR MECHANICAL PART OF WIND POWER GENERATION SYSTEM

(71) Applicant: Gaon Solution Co., Ltd., Jeollabuk-do (KR)

(72) Inventor: Sung Ho Kim, Jeollabuk-do (KR)

(73) Assignee: Gaon Solution Co., Ltd., Jeollabuk-do (KR)

(21) Appl. No.: 14/065,448

(22) Filed: Oct. 29, 2013

(30) Foreign Application Priority Data
Oct. 29, 2013 (KR) 10-2013-0129149
Oct. 29, 2013 (KR) 10-2013-0129156

(51) Int. Cl. F03D 11/00

(52) U.S. Cl. CPC F03D 11/0091
USPC 73/865.6

(57) ABSTRACT

Provided is a wind power generation system, more particularly a fault simulator for a mechanical part of a wind power generation system for education. The fault simulator includes a rotary shaft extending along a rotary axis line and rotatable based on the rotary axis line, a rotation driving unit for rotating the rotary shaft based on the rotary axis line, and a disk-type rotating disk coaxially fixed to the rotary shaft, wherein a plurality of mass coupling units to which a mass is detachably coupled is provided at the rotating disk.

### CROSS-REFERENCE TO RELATED APPLICATIONS AND CLAIM OF PRIORITY

This application claims priority under 35 U.S.C. §119 to Korean Patent Application Nos. 10-2013-0129149 filed on Oct. 29, 2013, 10-2013-0129156 filed on Oct. 29, 2013, in the Korean Intellectual Property Office, the disclosure of which is incorporated herein by reference in its entirety.

### TECHNICAL FIELD

The following disclosure relates to a wind power generation system, and in particular, to a fault simulator for a mechanical part of a wind power generation system.

### BACKGROUND

A wind power generation system produces power by converting wind energy into mechanical energy and driving a power generator. The wind power generation system is an environment-friendly power generator which is recently used more and more due to simple structure and easy installation. In order to agreeably maintain the wind power generation system, suitable educational equipment for the wind power generation system is required. Korean Unexamined Patent Publication No. 10-2013-0066832 discloses a fault simulator of a wind power generation system. However, this fault simulator of a wind power generation system is configured to simulate a fault of a controller of the wind power generation system, and a device for simulating a fault of a mechanical part of a wind power generation system is not yet developed.

### SUMMARY

An embodiment of the present invention is directed to providing a fault simulator for a mechanical part of a wind power generation system.

An embodiment of the present invention is also directed to providing an apparatus for simulating a mass unbalance failure of a wind power generation system.

An embodiment of the present invention is also directed to providing an apparatus for simulating an axial misalignment failure of a wind power generation system.

In one general aspect, there is provided a fault simulator for a mechanical part of a wind power generation system, which includes: a rotary shaft extending along a rotary axis line and rotatable based on the rotary axis line; a rotation driving unit for rotating the rotary shaft based on the rotary axis line; and a disk-type rotating disk coaxially fixed to the rotary shaft, wherein a plurality of mass coupling units to which a mass is detachably coupled is provided at the rotating disk. The mass coupling unit may have a through hole form.

The plurality of mass coupling units may include a plurality of first mass coupling units located on a circumference of a first radius with respect to the rotary axis line at regular intervals along the circumferential direction, and a plurality of second mass coupling units on a circumference of a second radius smaller than the first radius at regular intervals along the circumferential direction.

In another aspect, there is provided a fault simulator for a mechanical part of a wind power generation system, which includes: a fixed base unit; a movable base unit linearly movable with respect to the fixed base unit; a rotary shaft extending along a rotary axis line, rotatable based on the rotary axis line and installed at the movable base unit; a rotation driving unit having a driving shaft extending along the rotary axis line and installed at the fixed base unit; and a linear movement driving unit for moving the movable base unit with respect to the fixed base unit, wherein a first coupling unit is provided at an end of the driving shaft, and a second coupling unit coupled with the first coupling unit is provided at one end of the rotary shaft.

The moving direction of the movable base unit may be perpendicular to the rotary axis line.

The fault simulator for a mechanical part of a wind power generation system may further include a linear movement guiding unit for guiding linear movement of the movable base unit with respect to the fixed base unit.

The fault simulator for a mechanical part of a wind power generation system may further include a disk-type rotating disk coaxially fixed to the rotary shaft, and a plurality of mass coupling units to which a mass is detachably coupled may be provided at the rotating disk.

According to the present disclosure, all objects described above may be accomplished. In detail, since a disk having a plurality of coupling units to which a mass may be detachably coupled is provided at a rotary shaft, it is possible to simulate a mass unbalance failure of a wind power generation system. In addition, since a movable base unit to which a rotary shaft is fixed is coupled to be movable by an external force with respect to a fixed base unit to which a driving shaft is fixed, it is possible to stimulate an axial misalignment failure.

### BRIEF DESCRIPTION OF THE DRAWINGS

The above and other objects, features and advantages of the present disclosure will become apparent from the following description of certain exemplary embodiments given in conjunction with the accompanying drawings, in which:

FIG. 1 is a perspective view showing a fault simulator for a mechanical part of a wind power generation system according to an embodiment of the present disclosure;

FIG. 2 is a plane view showing the fault simulator for a mechanical part of a wind power generation system, depicted in FIG. 1;

FIG. 3 is a front view showing a fault simulator for a mechanical part of a wind power generation system, depicted in FIG. 1, which is used for education; and

FIG. 4 is a diagram showing a rotating disk of FIG. 1.

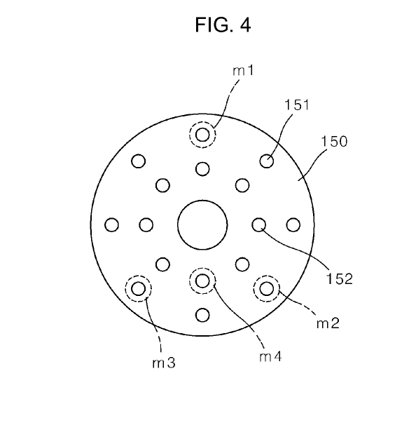

### DETAILED DESCRIPTION OF MAIN ELEMENTS

100: fault simulator for a mechanical part of a wind power generation system
110: fixed base unit
120: movable base unit
130: rotation driving unit
140: rotary shaft
150: rotating disk
160: power generator simulating unit
170: first linear movement guiding unit
180: second linear movement guiding unit
190: linear movement driving unit

### DETAILED DESCRIPTION OF EMBODIMENTS

Hereinafter, an embodiment will be described in detail with reference to the accompanying drawings.

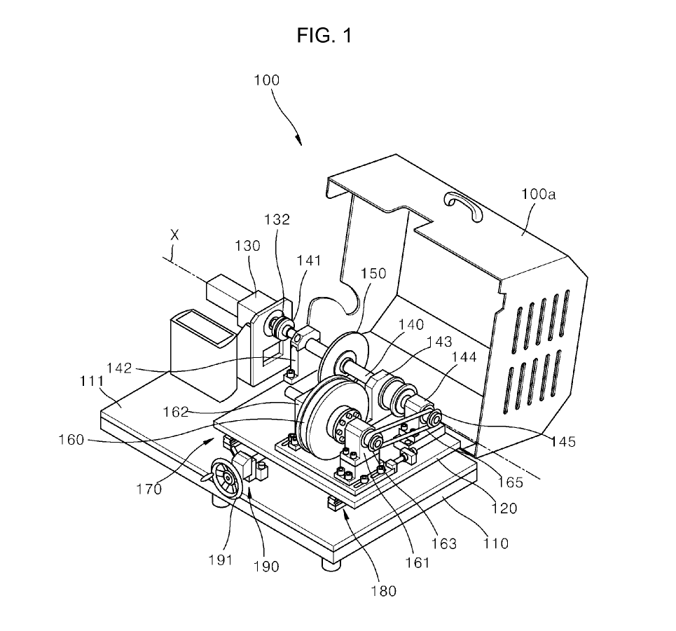

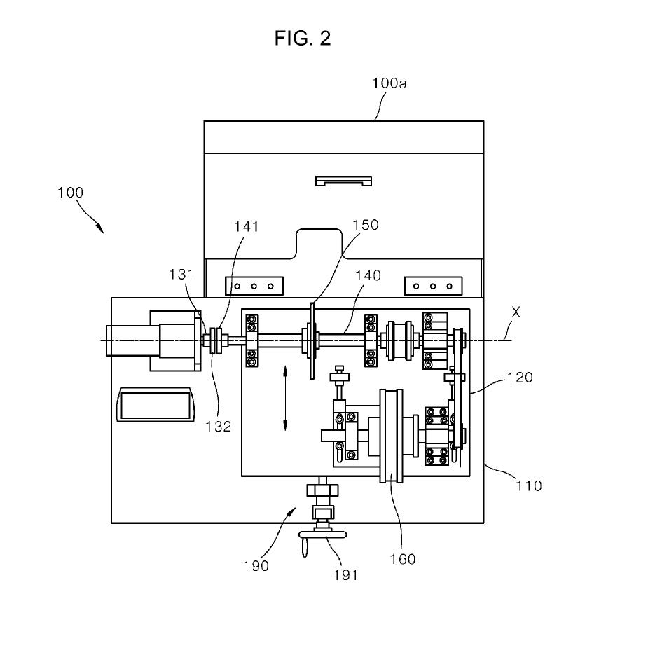

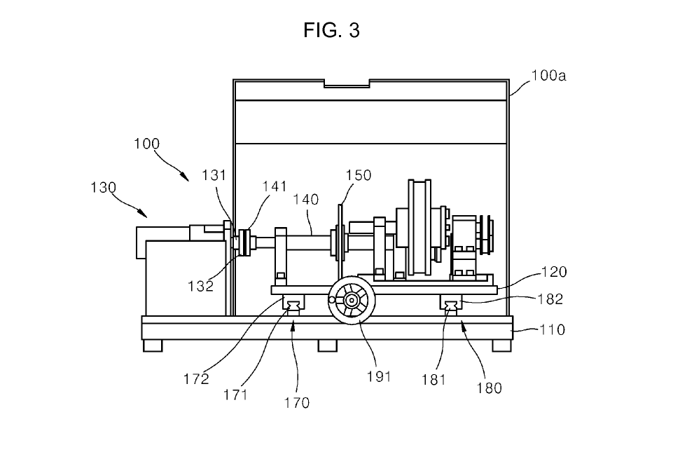

Referring to FIGS. 1 to 3, a fault simulator 100 for a mechanical part of a wind power generation system according to an embodiment of the present disclosure includes a fixed base unit 110, a movable base unit 120, a rotation driving unit 130, a rotary shaft 140, a rotating disk 150, a power generator simulating unit 160, linear movement guiding units 170, 180, a linear movement driving unit 190, and a cover 100a.

The fixed base unit 110 generally has a rectangular plate shape, and a fixed installation surface 111 having a flat shape is provided at the fixed base unit 110. The cover 100a is hinged to the fixed base unit 110.

The movable base unit 120 generally has a rectangular plate shape, and a movable installation surface 121 having a flat shape is provided at the movable base unit 120. The movable installation surface 121 is parallel to the fixed installation surface 111. The movable base unit 120 is coupled to the fixed base unit 110 to be linearly movable in an arrowed direction by means of the linear movement guiding units 170, 180. When the movable base unit 120 moves with respect to the fixed base unit 110, the fixed installation surface 111 and the movable installation surface 121 are kept in parallel to each other.

The rotation driving unit 130 is installed at the fixed installation surface 111. The rotation driving unit 130 extends along a rotary axis line X and has a driving shaft 131 rotating based on the rotary axis line X. The rotation driving unit 130 gives a rotating force through the driving shaft 131. The rotary axis line X is parallel to the movable installation surface 121 and perpendicular to the moving direction of the movable base unit 120. A first coupling unit 132 is provided at an end of the driving shaft 131. The rotary shaft 140 is coaxially coupled through the first coupling unit 132. In this embodiment, the rotation driving unit 130 is an electric motor.

The rotary shaft 140 is rotatably supported by a plurality of shaft supports 142, 143, 144 fixed to the movable installation surface 121. The rotary shaft 140 extends along the rotary axis line X and is rotatable based on the rotary axis line X. A second coupling unit 141 coupled with the first coupling unit 132 is provided at one end of the rotary shaft 140. The first coupling unit 132 and the second coupling unit 141 are coupled by means of a coupling unit such as a bolt-nut. By the coupling of the first coupling unit 132 and the second coupling unit 141, the driving shaft 131 and the rotary shaft 140 extend on the rotary axis line X. A first pulley 145 is provided at the rotary shaft 140. Through a belt 165 connected to the first pulley 145, the rotation of the rotary shaft 140 is transferred to the power generator simulating unit 160. The shaft supports 142, 143 are configured to allow exchange of the rotary shaft 140. Therefore, in case of a bearing failure, a rotary shaft where the bearing failure occurs may be exchanged. In addition, though not shown in the figures, a plurality of vibration sensors is mounted to the shaft supports 142, 143. In case of mass unbalancing, a vibration characteristic occurring in the radial direction is measured by the vibration sensor, and in case of axial misalignment, a vibration characteristic occurring in the axial direction is measured by the vibration sensor.

The rotating disk 150 has a disk shape and is coaxially coupled to the rotary shaft 140. In other words, the rotary axis line X passes perpendicularly through the center of the rotating disk 150. A plurality of mass coupling units 151, 152 to which masses m1, m2, m3, m4 may be detachably coupled is provided at the rotating disk 150. In this embodiment, the mass coupling units 151, 152 are through holes, but the present disclosure is not limited to the case where the mass coupling units 151, 152 are through holes. The plurality of mass coupling units 151, 152 includes a plurality of first mass coupling units 151 located on the circumference of a first radius at regular intervals along the circumferential direction, and a plurality of second mass coupling units 152 located on the circumference of a second radius smaller than the first radius at regular intervals along the circumferential direction. The masses m1, m2, m3, m4 may be suitably coupled to the mass coupling units 151, 152 of the rotating disk 150 to form a desired mass unbalance state.

The power generator simulating unit 160 is installed on the movable installation surface 121 and moves together with the movable base unit 120. The power generator simulating unit 160 provides a load corresponding to a power generator of the wind power generation system. The power generator simulating unit 160 is rotatably supported by two supports 161, 162 fixed to the movable installation surface 121. A second pulley 163 connected to the belt 165 is provided at the power generator simulating unit 160.

The linear movement guiding units 170, 180 guide the movable base unit 120 to be linearly movable in the arrowed direction with respect to the fixed base unit 110. The linear movement guiding units 170, 180 includes a first linear movement guiding unit 170 and a second linear movement guiding unit 180. The first linear movement guiding unit 170 is a linear motion guide and includes a first rail unit 171 fixed to the fixed base unit 110 and a first movable block 172 fixed to the movable base unit 110 and coupled to the first rail unit 171 to be slidably movable along the arrowed direction. The second linear movement guiding unit 180 is also a linear motion guide and includes a second rail unit 181 fixed to the fixed base unit 110 and a second movable block 182 fixed to the movable base unit 110 and coupled to the second rail unit 181 to be slidably movable along the arrowed direction.

The linear movement driving unit 190 drives the movable base unit 120 to linearly move along the arrowed direction with respect to the fixed base unit 110. The linear movement driving unit 190 includes a rotation unit 191 and a linear movement unit (not shown). The rotation unit 191 is fixed to the fixed base unit 110 and rotates by an external force. In this embodiment, the rotation unit 191 is manually rotated bi-directionally. The linear movement unit (not shown) is fixed to the movable base unit 120 and moves in both arrowed directions according to a rotating direction of the rotation unit 191. The linear movement unit (not shown) and the rotation unit 191 may be coupled to each other by means of a suitable motion transducer which converts a rotation into a linear movement. If the rotation unit 191 is rotated, the movable base unit 120 receives a force moving along the arrowed direction, and the rotary shaft 140 is distorted with respect to the driving shaft 131, which implements axial misalignment.

The cover 100a is hinged to the fixed base unit 110. The cover 100a covers or exposes components coupled to the movable base unit 120 as necessary.

Now, operations of this embodiment will be described in detail with reference to the accompanying drawings.

First, an operation for simulating a mass unbalance failure by using the fault simulator 100 for a mechanical part of a wind power generation system will be described. At the wind power generation system, mass unbalance is generated by unbalance of blades. In order to simulate a mass unbalance failure, the fault simulator 100 for a mechanical part of a wind power generation system suitably couples the masses m1, m2, m3, m4 to the mass coupling units 151, 152 of the rotating disk 150 and rotates the rotary shaft 140 by using the rotation driving unit 130, thereby implementing a desired unbalance state.

Next, an operation of simulating an axial misalignment failure by using the fault simulator 100 for a mechanical part of a wind power generation system will be described. In a state where the rotation driving unit 130 is not in operation, if the rotation unit 191 of the linear movement driving unit 190 is manually rotated, the movable base unit 120 receives a force moving along the arrowed direction, and the rotary shaft 140 is distorted with respect to the driving shaft 131, thereby implementing an axial misalignment state.

In addition, since the rotary shaft 140 may be separated from the shaft supports 142, 143, a rotary shaft where a bearing failure occurs may be exchanged. Moreover, by means of a plurality of vibration sensors installed at the shaft supports 142, 143, a vibration characteristic in the radial direction may be measured in case of mass unbalance, and a vibration characteristic in the axial direction may also be measured in case of axial misalignment.

Though the present disclosure has been described with reference to the embodiments depicted in the drawings, the present disclosure is not limited thereto. It should be understood by those skilled in the art that various modifications and equivalents can be made from the disclosure, and, such modifications should be regarded as being within the scope of the present disclosure.

What is claimed is:

1. A fault simulator for a mechanical part of a wind power generation system, comprising:
a rotary shaft extending along a rotary axis line and rotatable based on the rotary axis line;
a rotation driving unit for rotating the rotary shaft based on the rotary axis line; and
a disk-type rotating disk coaxially fixed to the rotary shaft,
wherein a plurality of mass coupling units to which a mass is detachably coupled is provided at the rotating disk.

2. The fault simulator for a mechanical part of a wind power generation system according to claim 1, wherein the mass coupling unit has a through hole form.

3. The fault simulator for a mechanical part of a wind power generation system according to claim 1, wherein the plurality of mass coupling units includes:
a plurality of first mass coupling units located on a circumference of a first radius with respect to the rotary axis line at regular intervals along the circumferential direction, and
a plurality of second mass coupling units on a circumference of a second radius smaller than the first radius at regular intervals along the circumferential direction.

4. A fault simulator for a mechanical part of a wind power generation system, comprising:
a fixed base unit;
a movable base unit linearly movable with respect to the fixed base unit;
a rotary shaft extending along a rotary axis line, rotatable based on the rotary axis line and installed at the movable base unit;
a rotation driving unit having a driving shaft extending along the rotary axis line and installed at the fixed base unit; and
a linear movement driving unit for moving the movable base unit with respect to the fixed base unit,
wherein a first coupling unit is provided at an end of the driving shaft, and a second coupling unit coupled with the first coupling unit is provided at one end of the rotary shaft.

5. The fault simulator for a mechanical part of a wind power generation system according to claim 4, wherein the moving direction of the movable base unit is perpendicular to the rotary axis line.

6. The fault simulator for a mechanical part of a wind power generation system according to claim 4, further comprising a linear movement guiding unit for guiding linear movement of the movable base unit with respect to the fixed base unit.

7. The fault simulator for a mechanical part of a wind power generation system according to claim 4, further comprising a disk-type rotating disk coaxially fixed to the rotary shaft,
wherein a plurality of mass coupling units to which a mass is detachably coupled is provided at the rotating disk.

8. The fault simulator for a mechanical part of a wind power generation system according to claim 4, further comprising a shaft support for rotatably coupling the rotary shaft to the movable base unit,
wherein the rotary shaft is detachably coupled to the shaft support.
